(19) United States
(12) Patent Application Publication
(10) Pub. No.: US 2009/0089329 A1
(43) Pub. Date: Apr. 2, 2009

(54) Systems and methods for the dynamic generation of repeat libraries for uncharacterized species

(76) Inventors: Charles F. Nelson, III, San Carlos, CA (US); Jing Gao, San Jose, CA (US); Amitabh Shukla, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/906,025

(22) Filed: Sep. 28, 2007

(51) Int. Cl. G06F 17/30

(52) U.S. Cl. 707/104.1; 707/E17.005

(57) ABSTRACT

Systems and methods for using the same for dynamically generating repeat libraries for use in detecting and for masking out repetitive elements in species having poorly characterized genomes or transcriptomes based on phylogenetic analysis are provided herein. Dynamically generated repeat libraries find use, for example, in the design and use of probes for identification of specific targets in these poorly characterized species.

### BACKGROUND

Biomolecular probes, such as nucleic acids and polypeptides, have become an increasingly important tool in the biotechnology industry and related fields.

One area in which biomolecular probes are of particular use is in the generation and use of biopolymeric arrays. Biopolymeric arrays generally include regions having different probes (i.e., having different sequences) arranged in a predetermined configuration on a substrate. These regions (sometimes referenced as “features”) are positioned at respective locations (“addresses”) on the substrate. The arrays, when exposed to a sample, will exhibit an observed binding pattern which can be detected upon interrogating the array. By correlating the observed binding pattern with the known locations of the annotated biopolymeric probes on the array, one can determine the presence and/or concentration of one or more probe-binding components of the sample.

For a biomolecular probe to be of useful in a particular target binding assay, it needs to bind specifically to its intended target and not to other, non-related targets. As such, probes designed for a specific target must avoid the inclusion of regions that bind to repetitive sequences present in the genome.

However, it is difficult to avoid the problems associated with repetitive sequences in a probe/target binding assay performed in a species having a non- or poorly-characterized genome or transcriptome. The present invention is drawn to addressing this, and other, needs.

### SUMMARY OF THE INVENTION

Systems and methods for using the same for dynamically generating repeat libraries for use in detecting and for masking out repetitive elements in species having poorly characterized genomes or transcriptomes based on phylogenetic analysis are provided herein. Dynamically generated repeat libraries find use, for example, in the design and use of probes for identification of specific targets in these poorly characterized species.

Aspects of the present invention include systems for generating a repeat library for a species of interest, the systems including: (A) a communication module having an input manager for receiving input from a user and an output manager for communicating output to a user, and (B) a processing module. The processing module includes: (1) a node manager configured to obtain a phylogenetic tree for a species of interest based on input from a user, where the phylogenetic tree includes a target node and non-target nodes, where the species of interest is the target node and species related to the species of interest are the non-target nodes and obtain a target node relatedness value for each non-target node; and (2) a repeat library manager, wherein the repeat library manager is configured to (a) identify a non-target node having a known repeat library in the phylogenetic tree; and (b) generating a repeat library for the species of interest based on the known repeat library of the identified non-target node and its respective target node relatedness value.

In certain embodiments, the user input is selected from: a species indicator for the species of interest, a phylogenetic tree for the species of interest, a choice of phylogenetic tree generating algorithm, a species indicator for one or more of the related species.

In certain embodiments, the repeat library manager is configured to identify multiple non-target nodes having a known repeat library in the phylogenetic tree.

In certain embodiments, the node manager is further configured to exclude from the generating step any of the identified non-target nodes if its respective target node relatedness value exceeds a threshold value.

In certain embodiments, the threshold value is provided by a user of the system.

In certain embodiments, the repeat library manager is further configured to prompt the user if all of the identified non-target nodes are excluded. In certain embodiments, the target node relatedness value is selected from one or more of: a bonus value, a cost value, and a certainty value.

In certain embodiments, the repeat library manager is further configured to communicate to the user the generated repeat library for the species of interest. In certain embodiments, the node manager is further configured to allow the user to select which of the non-target nodes in the phylogenetic tree to use for generating the repeat library for the species of interest.

In certain embodiments, the node manager is configured to obtain multiple phylogenetic trees for the species of interest, wherein the one or more target node relatedness value for each non-target node is based on a summation of the multiple phylogenetic trees.

Aspect of the present invention include methods of generating a repeat library for a species of interest including the steps of: (a) identifying by a user a species of interest; (b) obtaining a phylogenetic tree for the species of interest, wherein the phylogenetic tree includes a target node and non-target nodes, wherein the species of interest is the target node and species related to the species of interest are the non-target nodes, and wherein each non-target node includes a target node relatedness value; (c) identifying a non-target node in the phylogenetic tree having a known repeat library; (d) generating a repeat library for the species of interest based on the known repeat library and the target node relatedness value; and (e) outputting the generated repeat library for the species of interest to the user.

In certain embodiments, multiple non-target nodes having a known repeat library are identified in the phylogenetic tree.

In certain embodiments, the method further includes selecting by the user non-target nodes to be used in the generating step from the identified non-target nodes in the phylogenetic tree having known repeat libraries.

In certain embodiments, the obtaining the phylogenetic tree is selected from: producing a phylogenetic tree de novo and retrieving a previously produced phylogenetic tree.

In certain embodiments, the previously produced phylogenetic tree is provided by the user.

In certain embodiments, the any of the identified non-target nodes is excluded from the generating step if its respective target node relatedness value exceeds a threshold value.

In certain embodiments, the threshold value is input by the user.

In certain embodiments, the method further includes lowering the threshold value if all of the identified non-target nodes are excluded.

In certain embodiments, the target node relatedness value is selected from one or more of: a bonus value, a cost value, and a certainty value.

In certain embodiments, the outputting to the user is via the internet.

In certain embodiments, multiple phylogenetic trees are obtained for the species of interest, and the target node relatedness value for each non-target node is based on a summation of the multiple phylogenetic trees (e.g., a summation of the target node relatedness values for a given non-target node).

Aspects of the present invention include computer program products including a computer readable storage medium having a computer program stored thereon, wherein the computer program, when loaded onto a computer, operates the computer to generate a repeat library for a species of interest by: (a) obtaining a phylogenetic tree for the species of interest, wherein the phylogenetic tree includes nodes representing each species in the phylogenetic tree, wherein the species of interest is the target node, and wherein each non-target node includes one or more target node relatedness value; (b) identifying non-target nodes in the phylogenetic tree having known repeat libraries; and (c) generating a repeat library for the species of interest based on the known repeat libraries and the one or more target node relatedness value.

Aspects of the present invention include methods of receiving repeat library for a species of interest, the method comprising: (a) inputting a species of interest into the system of claim 1; and (b) receiving a repeat library for the species of interest.

In certain embodiments the method further includes inputting a threshold value for one or more target node relatedness value.

In certain embodiments the method further includes selecting an identified non-target node having a known repeat library to be used in the generating step.

### BRIEF DESCRIPTIONS OF THE DRAWINGS

FIG. 1 illustrates a substrate carrying multiple arrays, such as may be fabricated by methods of the present invention.

FIG. 2 is an enlarged view of a portion of FIG. 1 showing multiple ideal spots or features.

FIG. 3 is an enlarged illustration of a portion of the substrate in FIG. 2.

FIG. 4 schematically illustrates an exemplary system of the present invention.

FIG. 5 provides a flow chart of an exemplary repeat library generating method of the present invention.

FIG. 6 shows an exemplary phylogenetic tree having nodes as described herein. In this figure, target node 710 needs a repeat library generated for it. Such a repeat library can be based on a related non-target node that has a repeat library associated with it (also called a “full” non-target node; 730, 732, 734 and 736 in this figure). For example, the repeat library generated for the target node 710 may include repeat library elements from “full” sister node 736 and “full” parent nodes 732 and 730. Alternatively, if no “full” sister or parent nodes are available, the repeat library for “full” node 734 may be used to generate the repeat library for target node 710.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

By “array layout” is meant a collection of information, e.g., in the form of a file, which represents the location of probes that have been assigned to specific features of one or more array formats, e.g., a single array format or two or more array formats of an array set.

The phrase “array format” refers to a format that defines an array by feature number, feature size, cartesian coordinates of each feature, and distance that exists between features within a given single array.

The phrase “array content information” is used to refer to any type of information/data that describes an array. Representative types of array content information include, but are not limited to: “probe-level information” and “array-level information”. By “probe-level information” is meant any information relating to the biochemical properties or descriptive characteristics of a probe. Examples include, but are not limited to: probe sequence, melting temperature (Tₘ), target gene or genes (e.g., gene name, accession number, etc.), location identifier information, information regarding cell(s) or tissue(s) in which a probe sequence is expressed and/or levels of expression, information concerning physiological responses of a cell or tissue in which the sequence is expressed (e.g., whether the cell or tissue is from a patient with a disease), chromosomal location information, copy number information, information relating to similar sequences (e.g., homologous, paralogous or orthologous sequences), frequency of the sequence in a population, information relating to polymorphic variants of the probe sequence (e.g., such as SNPs), information relating to splice variants (e.g., tissues, individuals in which such variants are expressed), demographic information relating to individual(s) in which the sequence is found, and/or other annotation information. By “array-level information” is meant information relating to the physical properties or intended use of an array. Examples include, but are not limited to: types of genes to be studied using the array, such as genes from a specific species (e.g., mouse, human), genes associated with specific tissues (e.g., liver, brain, cardiac), genes associated with specific physiological functions, (e.g., apoptosis, stress response), genes associated with disease states (e.g., cancer, cardiovascular disease), array format information, e.g., feature number, feature size, cartesian coordinates of each feature, and distance that exists between features within a given array, etc.

A “data element” represents a property of a probe sequence, which can include the base composition of the probe sequence. Data elements can also include representations of other properties of probe sequences, such as expression levels in one or more tissues, interactions between a sequence (and/or its encoded products), and other molecules, a representation of copy number, a representation of the relationship between its activity (or lack thereof) in a cellular pathway (e.g., a signaling pathway) and a physiological response, sequence similarity to other probe sequences, a representation of its function, a representation of its modified, processed, and/or variant forms, a representation of splice variants, the locations of introns and exons, functional domains etc. A data element can be represented for example, by an alphanumeric string (e.g., representing bases), by a number, by “plus” and “minus” symbols or other symbols, by a color hue, by a word, or by another form (descriptive or nondescriptive) suitable for computation, analysis and/or processing for example, by a computer or other machine or system capable of data integration and analysis.

As used herein, the term “data structure” is intended to mean an organization of information, such as a physical or logical relationship among data elements, designed to support specific data manipulation functions, such as an algorithm. The term can include, for example, a list or other collection type of data elements that can be added, subtracted, combined or otherwise manipulated. Exemplary types of data structures include a list, linked-list, doubly linked-list, indexed list, table, matrix, queue, stack, heap, dictionary, flat file databases, relational databases, local databases, distributed databases, thin client databases and tree. The term also can include organizational structures of information that relate or correlate, for example, data elements from a plurality of data structures or other forms of data management structures. A specific example of information organized by a data structure of the invention is the association of a plurality of data elements relating to a gene, e.g., its sequence, expression level in one or more tissues, copy number, activity states (e.g., active or non-active in one or more tissues), its modified, processed and/or and/or variant forms, splice variants encoded by the gene, the locations of introns and exons, functional domains, interactions with other molecules, function, sequence similarity to other probe sequences, etc. A data structure can be a recorded form of information (such as a list) or can contain additional information (e.g., annotations) regarding the information contained therein. A data structure can include pointers or links to resources external to the data structure (e.g., such as external databases). In one aspect, a data structure is embodied in a tangible form, e.g. is stored or represented in a tangible medium (such as a computer readable medium).

The term “object” refers to a unique concrete instance of an abstract data type, a class (that is, a conceptual structure including both data and the methods to access it) whose identity is separate from that of other objects, although it can “communicate” with them via messages. In some occasions, some objects can be conceived of as a subprogram which can communicate with others by receiving or giving instructions based on its, or the others' data or methods. Data can consist of numbers, literal strings, variables, references, etc. In addition to data, an object can include methods for manipulating data. In certain instances, an object may be viewed as a region of storage. In the present invention, an object typically includes a plurality of data elements and methods for manipulating such data elements.

A “relation” or “relationship” is an interaction between multiple data elements and/or data structures and/or objects. A list of properties may be attached to a relation. Such properties may include name, type, location, etc. A relation may be expressed as a link in a network diagram. Each data element may play a specific “role” in a relation.

As used herein, an “annotation” is a comment, explanation, note, link, or metadata about a data element, data structure or object, or a collection thereof. Annotations may include pointers to external objects or external data. An annotation may optionally include information about an author who created or modified the annotation, as well as information about when that creation or modification occurred. In one embodiment, a memory comprising a plurality of data structures organized by annotation category provides a database through which information from multiple databases, public or private, may be accessed, assembled, and processed. Annotation tools include, but are not limited to, software such as BioFerret (available from Agilent Technologies, Inc., Palo Alto, Calif.), which is described in detail in application Ser. No. 10/033,823 filed Dec. 19, 2001 and titled “Domain-Specific Knowledge-Based Metasearch System and Methods of Using.” Such tools may be used to generate a list of associations between genes from scientific literature and patent publications.

As used herein an “annotation category” is a human readable string to annotate the logical type that an object comprising its plurality of data elements represents. Data structures that contain the same types and instances of data elements may be assigned identical annotations, while data structures that contain different types and instances of data elements may be assigned different annotations.

As used herein, a “species identifier” or an “identifier corresponding to a species” refers to a string of one or more characters (e.g., alphanumeric characters), symbols, images or other graphical representation(s) associated with a species of interest. In one aspect, an identifier comprises a name containing a genus and species designation (e.g., Homo sapiens, Canis familiaris, etc.).

The phrase “best-fit” refers to a resource allocation scheme that determines the best result in response to input data. The definition of ‘best’ may vary depending on a given set of predetermined parameters, such as sequence identity limits, signal intensity limits, cross-hybridization limits, Tₘ, base composition limits, probe length limits, distribution of bases along the length of the probe, distribution of nucleation points along the length of the probe (e.g., regions of the probe likely to participate in hybridization, secondary structure parameters, etc. In one aspect, the system considers predefined thresholds. In another aspect, the system rank-orders fit. In a further aspect, the user defines his or her own thresholds, which may or may not include system-defined thresholds.

The terms “system” and “computer-based system” refer to the hardware means, software means, and data storage means used to analyze the information of the present invention. The minimum hardware of the computer-based systems of the present invention comprises a central processing unit (CPU), input means, output means, and data storage means. As such, any convenient computer-based system may be employed in the present invention. The data storage means may comprise any manufacture comprising a recording of the present information as described above, or a memory access means that can access such a manufacture.

A “processor” references any hardware and/or software combination which will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

“Computer readable medium” as used herein refers to any storage or transmission medium that participates in providing instructions and/or data to a computer for execution and/or processing. Examples of storage media include floppy disks, magnetic tape, UBS, CD-ROM, a hard disk drive, a ROM or integrated circuit, a magneto-optical disk, or a computer readable card such as a PCMCIA card and the like, whether or not such devices are internal or external to the computer. A file containing information may be “stored” on computer readable medium, where “storing” means recording information such that it is accessible and retrievable at a later date by a computer. A file may be stored in permanent memory.

With respect to computer readable media, “permanent memory” refers to memory that is permanently stored on a data storage medium. Permanent memory is not erased by termination of the electrical supply to a computer or processor. Computer hard-drive ROM (i.e. ROM not used as virtual memory), CD-ROM, floppy disk and DVD are all examples of permanent memory. Random Access Memory (RAM) is an example of non-permanent memory. A file in permanent memory may be editable and re-writable.

To “record” data, programming or other information on a computer readable medium refers to a process for storing information, using any convenient method. Any convenient data storage structure may be chosen, based on the means used to access the stored information. A variety of data processor programs and formats can be used for storage, e.g. word processing text file, database format, etc.

A “memory” or “memory unit” refers to any device which can store information for subsequent retrieval by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

In certain embodiments, a system includes hardware components which take the form of one or more platforms, e.g., in the form of servers, such that any functional elements of the system, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any convenient type of computer platform, e.g., such as a server, main-frame computer, a work station, etc. Where more than one platform is present, the platforms may be connected via any convenient type of connection, e.g., cabling or other communication system including wireless systems, either networked or otherwise. Where more than one platform is present, the platforms may be co-located or they may be physically separated. Various operating systems may be employed on any of the computer platforms, where representative operating systems include Windows, MacOS, Sun Solaris, Linux, OS/400, Compaq Tru64 Unix, SGI IRIX, Siemens Reliant Unix, and others. The functional elements of system may also be implemented in accordance with a variety of software facilitators, platforms, or other convenient method.

Items of data are “linked” to one another in a memory when the same data input (for example, filename or directory name or search term) retrieves the linked items (in a same file or not) or an input of one or more of the linked items retrieves one or more of the others.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In general, synthesis of nucleic acids of this type utilizes an initial substrate-bound monomer that is used as a building-block in a multi-step synthesis procedure to form a complete nucleic acid. A “biomonomer” references a single unit, which can be linked with the same or other biomonomers to form a biopolymer (e.g., a single amino acid or nucleotide with two linking groups, one or both of which may have removable protecting groups).

The terms “nucleoside” and “nucleotide” are intended to include those moieties which contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

As used herein, the term “amino acid” is intended to include not only the L, D- and nonchiral forms of naturally occurring amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine), but also modified amino acids, amino acid analogs, and other chemical compounds which can be incorporated in conventional oligopeptide synthesis, e.g., 4-nitrophenylalanine, isoglutamic acid, isoglutamine, ε-nicotinoyl-lysine, isonipecotic acid, tetrahydroisoquinoleic acid, α-aminoisobutyric acid, sarcosine, citrulline, cysteic acid, t-butylglycine, t-butylalanine, phenylglycine, cyclohexylalanine, β-alanine, 4-aminobutyric acid, and the like.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure. In the practice of the instant invention, oligomers will generally comprise about 2-50 monomers, preferably about 2-20, more preferably about 3-10 monomers.

The term “polymer” means any compound that is made up of two or more monomeric units covalently bonded to each other, where the monomeric units may be the same or different, such that the polymer may be a homopolymer or a heteropolymer. Representative polymers include peptides, polysaccharides, nucleic acids and the like, where the polymers may be naturally occurring or synthetic.

A “biopolymer” is a polymer of one or more types of repeating units. Biopolymers are typically found in biological systems (although they may be made synthetically) and may include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. For example, a “biopolymer” may include DNA (including cDNA), RNA, oligonucleotides, and PNA and other polynucleotides as described in U.S. Pat. No. 5,948,902 and references cited therein (all of which are incorporated herein by reference), regardless of the source.

The term “biomolecular probe” or “probe” means any organic or biochemical molecule, group or species of interest having a particular sequence or structure. In certain embodiments, a biomolecular probe may be formed in an array on a substrate surface. Exemplary biomolecular probes include polypeptides, proteins, oligonucleotide and polynucleotides.

The term “ligand” as used herein refers to a moiety that is capable of covalently or otherwise chemically binding a compound of interest. The arrays of solid-supported ligands produced by the methods can be used in screening or separation processes, or the like, to bind a component of interest in a sample. The term “ligand” in the context of the invention may or may not be an “oligomer” as defined above. However, the term “ligand” as used herein may also refer to a compound that is “pre-synthesized” or obtained commercially, and then attached to the substrate.

The term “sample” as used herein relates to a material or mixture of materials, typically, although not necessarily, in fluid form, containing one or more components of interest.

A biomonomer fluid or biopolymer fluid refers to a liquid containing either a biomonomer or biopolymer, respectively (typically in solution).

The term “peptide” as used herein refers to any polymer compound produced by amide formation between an α-carboxyl group of one amino acid and an a-amino group of another group.

The term “oligopeptide” as used herein refers to peptides with fewer than about 10 to 20 residues, i.e., amino acid monomeric units.

The term “polypeptide” as used herein refers to peptides with more than 10 to 20 residues.

The term “protein” as used herein refers to polypeptides of specific sequence of more than about 5.0 residues.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single-stranded nucleotide multimers of from about 10 up to about 200 nucleotides in length, e.g., from about 25 to about 200 nt, including from about 50 to about 175 nt, e.g. 150 nt in length

The term “polynucleotide” as used herein refers to single- or double-stranded polymers composed of nucleotide monomers of generally greater than about 100 nucleotides in length.

An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. As such, an addressable array includes any one or two or even three-dimensional arrangement of discrete regions (or “features”) bearing particular biopolymer moieties (for example, different polynucleotide sequences) associated with that region and positioned at particular predetermined locations on the substrate (each such location being an “address”). These regions may or may not be separated by intervening spaces. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

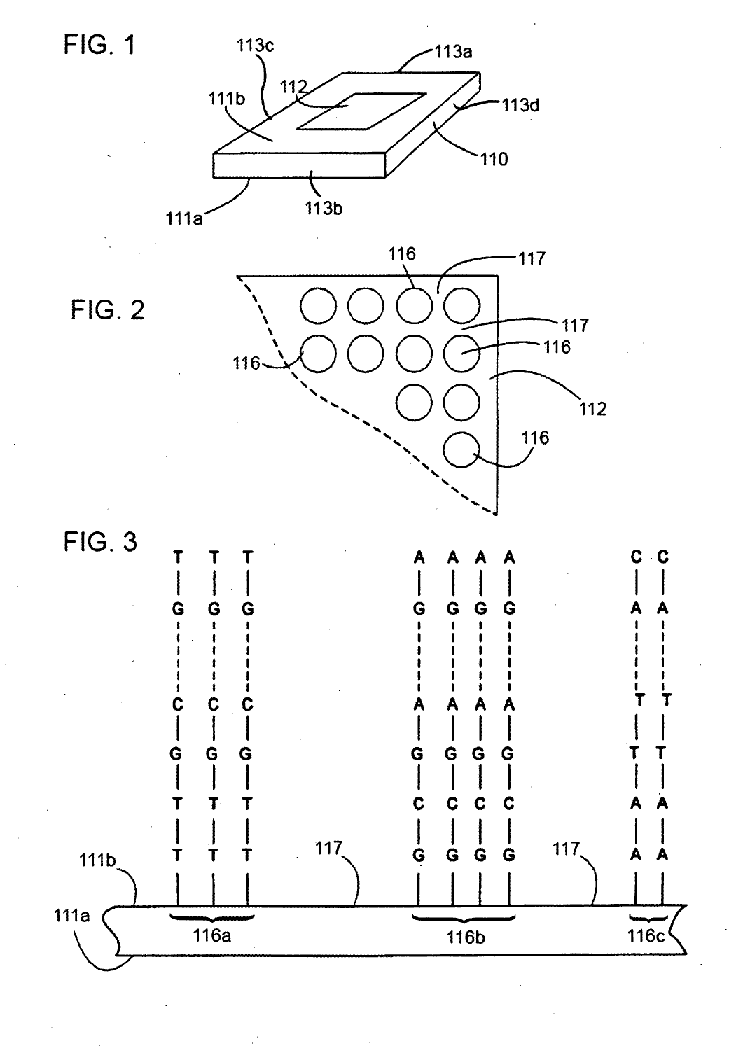

An exemplary chemical array is shown in FIGS. 1-3, where the array shown in this representative embodiment includes a contiguous planar substrate 110 carrying an array 112 disposed on a surface 111b of substrate 110. It will be appreciated though, that more than one array (any of which are the same or different) may be present on surface 111b, with or without spacing between such arrays. That is, any given substrate may carry one, two, four or more arrays disposed on a front surface of the substrate and depending on the use of the array, any or all of the arrays may be the same or different from one another and each may contain multiple spots or features. The one or more arrays 112 usually cover only a portion of the surface 111b, with regions of the rear surface 111b adjacent the opposed sides 113c, 113d and leading end 113a and trailing end 113b of slide 110, not being covered by any array 112. A second surface 111a of the slide 110 does not carry any arrays 112. Each array 112 can be designed for testing against any type of sample, whether a trial sample, reference sample, a combination of them, or a known mixture of biopolymers such as polynucleotides. Substrate 110 may be of any shape, as mentioned above.

As mentioned above, array 112 contains multiple spots or features 116 of biopolymer ligands, e.g., in the form of polynucleotides. As mentioned above, all of the features 116 may be different, or some or all could be the same. The interfeature areas 117 could be of various sizes and configurations. Each feature carries a predetermined biopolymer such as a predetermined polynucleotide (which includes the possibility of mixtures of polynucleotides). It will be understood that there may be a linker molecule (not shown) between the rear surface 111b and the first nucleotide. Any convenient linker may be used.

Substrate 110 may carry on surface 111a, an identification code, e.g., in the form of bar code (not shown) or the like printed on a substrate in the form of a paper label attached by adhesive or any convenient means. The identification code contains information relating to array 112, where such information may include, but is not limited to, an identification of array 112, i.e., layout information relating to the array(s), etc.

The substrate may be porous or non-porous. The substrate may have a planar or non-planar surface.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

An array “assembly” includes a substrate and at least one chemical array, e.g., on a surface thereof. Array assemblies may include one or more chemical arrays present on a surface of a device that includes a pedestal supporting a plurality of prongs, e.g., one or more chemical arrays present on a surface of one or more prongs of such a device. An assembly may include other features (such as a housing with a chamber from which the substrate sections can be removed). “Array unit” may be used interchangeably with “array assembly”.

The term “substrate” as used herein refers to a surface upon which marker molecules or probes, e.g., an array, may be adhered. Glass slides are the most common substrate for biochips, although fused silica, silicon, plastic and other materials are also suitable.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

A “web” references a long continuous piece of substrate material having a length greater than a width. For example, the web length to width ratio may be at least 5/1, 10/1, 50/1, 100/1, 200/1, or 500/1, or even at least 1000/1.

“Flexible” with reference to a substrate or substrate web, refers to a substrate that can be bent 180 degrees around a roller of less than 1.25 cm in radius. The substrate can be so bent and straightened repeatedly in either direction at least 100 times without failure (for example, cracking) or plastic deformation. This bending must be within the elastic limits of the material. The foregoing test for flexibility is performed at a temperature of 20° C.

“Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

“Hybridizing” and “binding”, with respect to polynucleotides, are used interchangeably.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1 M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions sets forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1 ×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions may also be employed, as appropriate.

“Contacting” means to bring or put together. As such, a first item is contacted with a second item when the two items are brought or put together, e.g., by touching them to each other.

“Depositing” means to position, place an item at a location-or otherwise cause an item to be so positioned or placed at a location. Depositing includes contacting one item with another. Depositing may be manual or automatic, e.g., “depositing” an item at a location may be accomplished by automated robotic devices.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information means transmitting the data representing that information as signals (e.g., electrical, optical, radio signals, and the like) over a suitable communication channel (for example, a private or public network).

“Forwarding” an item refers to any means of getting that item from one location to the next, whether by physically transporting that item or otherwise (where that is possible) and includes, at least in the case of data, physically transporting a medium carrying the data or communicating the data.

An array “package” may be the array plus only a substrate on which the array is deposited, although the package may include other features (such as a housing with a chamber).

A “chamber” references an enclosed volume (although a chamber may be accessible through one or more ports). It will also be appreciated that throughout the present application, that words such as “top,” “upper,” and “lower” are used in a relative sense only.

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

By “repeat library” or “repeat library set” is meant one or more nucleic acid sequences (e.g., stored in a database) that correspond to sequences that are present repeatedly in the genome (or transcriptome) of a given species and/or organism-type (sometimes called replicate regions). Replicate regions are poor candidates for unique probes due to their abundant distribution in the genome. Repeat masking using repeat library sets to identify and remove these segments/sequences from consideration during the probe design processes to avoid the potential for designing a probe thought to be specific for a single target site but that in reality has multiple targets in the genome. Repeat libraries generally known in the art include all known (i.e., sequenced) repeats for a given species and/or organism-type. As described below, aspects of the present invention are drawn to dynamically generating repeat libraries for poorly characterized species (i.e., species for which little or no sequence information is known). As such “generated repeat libraries” or “dynamically generated repeat libraries” according to aspects of the present invention are repeat libraries for which repeat regions are estimated based on repeat libraries of related species.

### DETAILED DESCRIPTION

Systems and methods for using the same for dynamically generating repeat libraries for use in detecting and for masking out repetitive elements in species having poorly characterized genomes or transcriptomes based on phylogenetic analysis are provided herein. Dynamically generated repeat libraries find use, for example, in the design and use of probes for identification of specific targets in these poorly characterized species.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

In the event that one or more of the incorporated literature and similar materials differs from or contradicts this application, including but not limited to defined terms, term usage, described techniques, or the like, this application controls.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Aspects of the invention include systems and methods for dynamically generating repeat libraries for a species of interest, where the species of interest has a poorly (or non) characterized genome and/or transcriptome (and thus a repeat library cannot be produced based on primary sequence data from that species). Representative embodiments of the subject systems generally include the following components: (a) a communications module for facilitating information transfer between the system and one or more users, e.g., via a user computer, as described below; and (b) a processing module for performing one or more tasks involved in the target probe set design methods of the invention. In representative embodiments, the subject systems may be viewed as being the physical embodiment of a web portal, where the term “web portal” refers to a web site or service, e.g., as may be viewed in the form of a web page, that offers a broad array of resources and services to users via an electronic communication element, e.g., via the Internet.

In certain embodiments, the subject systems are components of an array development system, including but not limited to those systems described in Published United States Application publication Nos. 20060116827; 20060116825 and 20060115822, as well as U.S. application Ser. Nos. 11/349,425; 11/349,398; 11/478,975; 11/479,014; and 11/478,973; the disclosures of which are herein incorporated by reference.

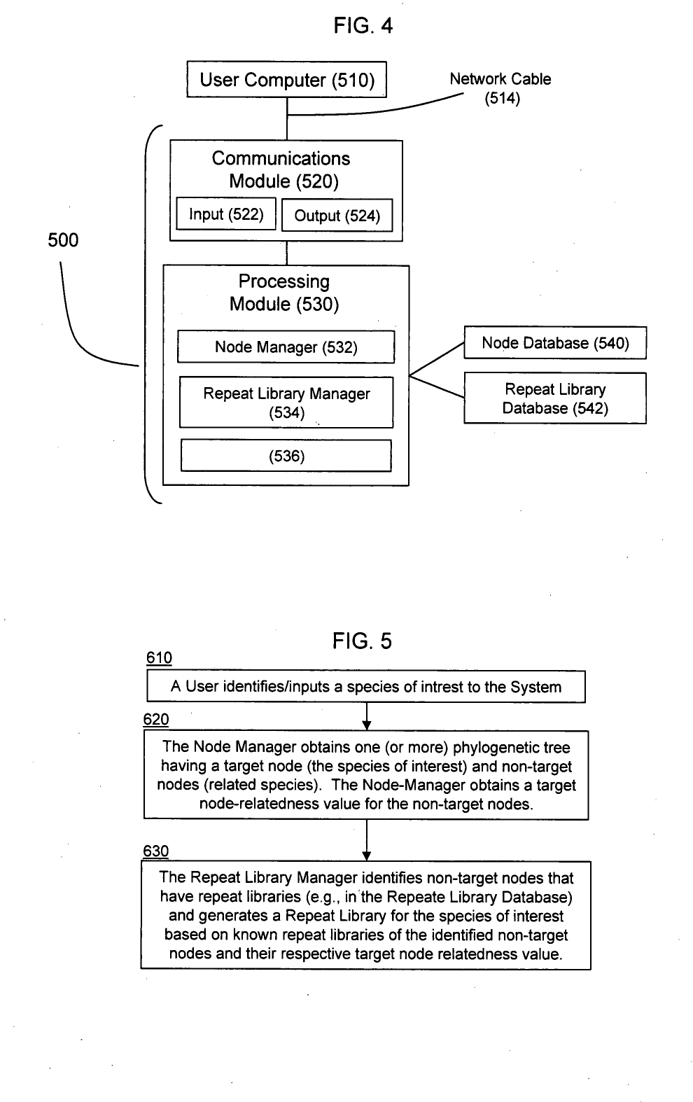

FIG. 4 provides a view of a representative dynamic repeat library generating system according to an embodiment of the subject invention. In FIG. 4, system 500 includes communications module 520 and processing module 530, where each module may be present on the same or different platforms, e.g., servers, as described above.

The communications module includes the input manager 522 and output manager 524 functional elements. Input manager 522 receives information from a user e.g., over the Internet. Input manager 522 processes and forwards this information to the processing module 530. These functions are implemented using any convenient method or technique. Another of the functional elements of communications module 520 is output manager 524. Output manager 524 provides information assembled by processing module 530 to a user, e.g., over the Internet. The presentation of data by the output manager may be implemented in accordance with any convenient methods or techniques. As some examples, data may include SQL, HTML or XML documents, email or other files, or data in other forms. The data may include Internet URL addresses so that a user may retrieve additional SQL, HTML, XML, or other documents or data from remote sources.

The communications module 520 may be operatively connected to a user computer 510, which provides a vehicle for a user to interact with the system 500. User computer 510, shown in FIG. 4, may be a computing device specially designed and configured to support and execute any of a multitude of different applications. Computer 510 also may be any of a variety of types of general-purpose computers such as a personal computer, network server, workstation, or other computer platform now or later developed. Computer 510 may include components such as a processor, an operating system, a graphical user interface (GUI) controller, a system memory, memory storage devices, and input-output controllers. There are many possible configurations of the components of computer 510 and some components are not listed above, such as cache memory, a data backup unit, and many other devices.

In certain embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein may be accomplished using any convenient method and techniques.

In certain embodiments, a user employs the user computer to enter information into and retrieve information from the system. As shown in FIG. 4, computer 510 is coupled via network cable 514 to the system 500. Additional computers of other users and/or administrators of the system in a local or wide-area network including an Intranet, the Internet, or any other network may also be coupled to system 500 via cable 514. It will be understood that cable 514 is merely representative of any type of network connectivity, which may involve cables, transmitters, relay stations, network servers, wireless communication devices, and many other components not shown that are suitable for this purpose. Via user computer 510, a user may operate a web browser served by a user-side Internet client to communicate via Internet with system 500. System 500 may similarly be in communication over Internet with other users, networks of users, and/or system administrators, as desired.

As reviewed above, the systems include various functional elements that carry out specific tasks on the platforms in response to information introduced into the system by one or more users. In FIG. 4, elements 532, and 534 and 536 represent three different functional elements of processing module 530. While three different functional elements are shown, it is noted that the number of functional elements may be more or less, depending on the particular embodiment of the invention. Representative functional elements that may be carried out by the processing module are now reviewed in greater detail below.

In certain embodiments, the subject system includes a node manager 532 and repeat library manager 534 as parts of the processing module 530, which is configured to perform functions relating to dynamically generating repeat libraries for a species of interest based upon input by a user. As indicated above, in certain embodiments the species of interest is poorly characterized at the nucleic acid level, meaning that its genome and/or transcriptome has not been substantially sequenced. Due of this paucity of sequence information, obtaining a known repeat library for the species of interest is not possible.

Node manager 532 is configured to: (a) obtain a phylogenetic tree for the species of interest based on input from a user (which will included a “target node” representing the species of interest as well as one or more “non-target nodes” representing species related to the species of interest); and (b) obtain a target node relatedness value for each non-target node in the phylogenetic tree. The user input can be any variety of input so long as it indicates a species of interest for which a dynamically generated repeat library is desired. Exemplary user input includes, but is not limited to: a species indicator for said species of interest (e.g., a species name), a species indicator for one or more species related to the species of interest, a pre-constructed phylogenetic tree for said species of interest (which includes target and non target nodes), and a phylogenetic tree algorithm identifier to use in producing a phylogenetic tree for the species of interest, etc.

As is generally known in the art, phylogenetic trees show the evolutionary interrelationships among various species that are believed to have a common ancestor. In a phylogenetic tree, each node represents a distinct species, where a node with one or more descendant nodes represents the most recent common ancestor for the descendant node(s). In some phylogenetic trees, the length of the edges (or linkers) between nodes sometimes corresponds to evolutionary time estimates or the amount of sequence variation between nodes (although this is not always the case).

Phylogenetic trees that find use in the subject invention can be of any convenient type. Exemplary types of phylogenetic trees include the following, the description of which is not meant to be limiting.

Rooted Trees: A rooted phylogenetic tree is a directed tree with one node serving as the most recent common ancestor of all the nodes present on the leaves of the tree. The most common method for rooting trees involves the use of an uncontroversial outgroup, which is close enough to allow inference from sequence or trait data, but far enough to be a clear outgroup.

Unrooted Trees: An unrooted phylogenetic tree illustrates the relatedness of the leaf nodes without making assumptions about common ancestry. While unrooted trees can always be generated from rooted ones by simply omitting the root, a root cannot be inferred from an unrooted tree without some means of identifying ancestry. This is normally done by including an outgroup in the input data or introducing additional assumptions about the relative rates of evolution on each branch, such as an application of the molecular clock hypothesis.

Both rooted and unrooted phylogenetic trees can be either bifurcating or multifurcating, and either labeled or unlabeled. A bifurcating tree has a maximum of two descendants arising from each interior node, while a multifurcating tree may have more than two. A labeled tree has specific values assigned to its leaves, while an unlabeled tree, sometimes called a tree shape, only defines a topology. The number of possible trees for a given number of leaf nodes depends on the specific type of tree, but there are always more multifurcating than bifurcating trees, more labeled than unlabeled trees, and more rooted than unrooted trees. The last distinction is the most biologically relevant; it arises because there are many places on an unrooted tree to put the root. For labeled bifurcating trees, there are total rooted trees and total unrooted trees, where n represents the number of leaf nodes. The number of unrooted trees for n input sequences or species is equal to the number of rooted trees for n-1 sequences.

A dendrogram is a broad term for the diagrammatic representation of a phylogenetic tree (i.e., as a relationship of nodes). A cladogram is a phylogenetic tree formed using cladistic methods which only represents a branching pattern, i.e., its branch lengths do not represent time. A phylogram is a phylogenetic tree that explicitly represents the number of character changes (e.g., nucleotide changes) through its branch lengths. An ultrametric tree or chronogram is a phylogenetic tree that explicitly represents evolutionary time through its branch lengths.

Phylogenetic trees among a nontrivial number of input sequences are constructed using computational phylogenetics methods. Distance-matrix methods such as neighbor-joining or UPGMA, which calculate genetic distance from multiple sequence alignments, are simplest to implement, but do not invoke an evolutionary model. Many sequence alignment methods such as ClustalW produce both sequence alignments and phylogenetic trees. Methods including maximum parsimony, maximum likelihood and Bayesian inference apply an explicit model of evolution to phylogenetics. Identifying the optimal tree using many of these techniques may be difficult, so heuristic search and optimization methods may be used in combination with tree-scoring functions to identify a reasonably good tree that fits the available data.

In obtaining a phylogenetic tree for the species of interest, the node manager may generate a phylogenetic tree based on the user input. For example, if the user inputs only a species of interest (e.g., by inputting a species identifier), the node manager may generate a phylogenetic tree using information stored in a node database (540). In certain embodiments, the node database includes previously-constructed phylogenetic trees which the node manager retrieves based on the user input (e.g., the node manager retrieves a phylogenetic tree that includes the species of interest input by a user as one of its nodes). As such, information in the node database can include any information related to phylogenetic trees, their construction, and information for individual nodes (or species).

For example, the node database may contain node relatedness information (e.g., values that indicate a node's relatedness to another node), sequence information that can be used as a basis for determining a node's relationship to other nodes (e.g., based on the similarity of their nucleic acid sequence for a specific genetic locus or transcript), and already constructed phylogenetic trees. The node database may include one or more public or private databases (or a combination of both). The node manager may be configured to use any convenient phylogenetic tree algorithm for generating a phylogenetic tree for the species of interest, which, in certain embodiments, the user can select or enter as part of the user input. In certain embodiments, the node manager operates a phylogenetic tree generating algorithm using default settings for various design parameters. In yet other embodiments, the node manager operates the phylogenetic tree generating (or design) algorithm using one or more parameters that have been set by a user, e.g., through use of an appropriate graphical user interface, such that the node manager designs one or more phylogenetic tree based in part on one or more parameter provided by the user. For example, the user may wish to exclude from or include specific nodes (or species) in the phylogenetic tree(s) obtained. As another example, the user may specify a genetic feature (e.g., gene, genetic locus, transcript, etc.) that is to be used as a basis for the relatedness of the species in generating the phylogenetic tree (e.g., a phylogenetic tree can be constructed based on sequence comparisons of ribosomal RNA). The number of nodes (in addition to the target node) in a phylogenetic tree obtained by the system may be between 1 and 100, where in certain embodiments the number of non-target nodes in a phylogenetic tree is between 5 and 50.

As noted above, the node manager of systems of the invention is also configured to obtain at least one target node relatedness value(s) for one or more nodes of the phylogenetic tree(s) obtained, where the target node relatedness value(s) represents the relatedness of a node of the phylogenetic tree to the target node. While a target node relatedness value may, in certain embodiments, be a qualitative value, such as good, fair, poor, etc., in certain embodiments, a target node relatedness value is provided in the form of a quantitative evaluation, such as a computationally determined score. As such, in certain embodiments the node manager is configured to calculate at least one target node relatedness value for at least one, if not all of, the non-target nodes in the obtained phylogenetic tree(s). The type of target node relatedness value may vary as desired, where in certain embodiments a target node relatedness value may include one or more of the following: a bonus value, a cost value, and a certainty value.

In certain embodiments, a target node relatedness value for a non-target node is based on a summation of target node relatedness values obtained from multiple phylogenetic trees (i.e., when the multiple phylogenetic trees contain common non-target nodes).

In certain embodiments, the node manager is configured to apply appropriate filters to the target node relatedness values, where a non-target node may be excluded from being considered in downstream steps (e.g., generating a repeat library for the target node) if one or more its respective target node relatedness value(s) exceed a threshold value. In certain embodiments, the threshold value is entered into the system by an administrator of the system, whereas in other embodiments, the threshold value is provided by a user of the system.

In certain embodiments, the node manager is configured to allow a user to select which of the non-target nodes in a phylogenetic tree(s) to use in generating the repeat library for the species of interest. For example, a system of the invention may display to a user on a GUI one or more phylogenetic trees obtained by the node manager, at which time a user may select a non-target node to either include or exclude in generating the repeat library for the target node (e.g., by clicking a non-target node on the GUI with a cursor controlled by a conventional computer mouse). In this way, the user can refine the data set from which the repeat library for the target node (or species of interest) is generated.

Systems of the invention also include a repeat library manager 534 configured to (a) identify one or more non-target node in the phylogenetic tree obtained by the node manager having a known repeat library; and (b) generate a repeat library for the species of interest based on the known repeat library of the identified non-target node(s) and its respective target node relatedness value. In certain embodiments, the system includes a repeat library database 542 containing information related to repeat libraries, including known repeat library sets (i.e., repeat library sets for well characterized species) as well as dynamically generated repeat libraries produced by the system itself. As such, in certain embodiments, the repeat library manager may retrieve a previously generated repeat library from the repeat library database in response to input from a user, e.g., if a user-indicated species of interest has already had a repeat library dynamically generated by the system, the repeat library manager may retrieve this repeat library.

In certain embodiments, the repeat library manager is further configured to communicate to a user a dynamically generated repeat library for the species of interest, i.e., through the output manager 524 of the communications module 520.

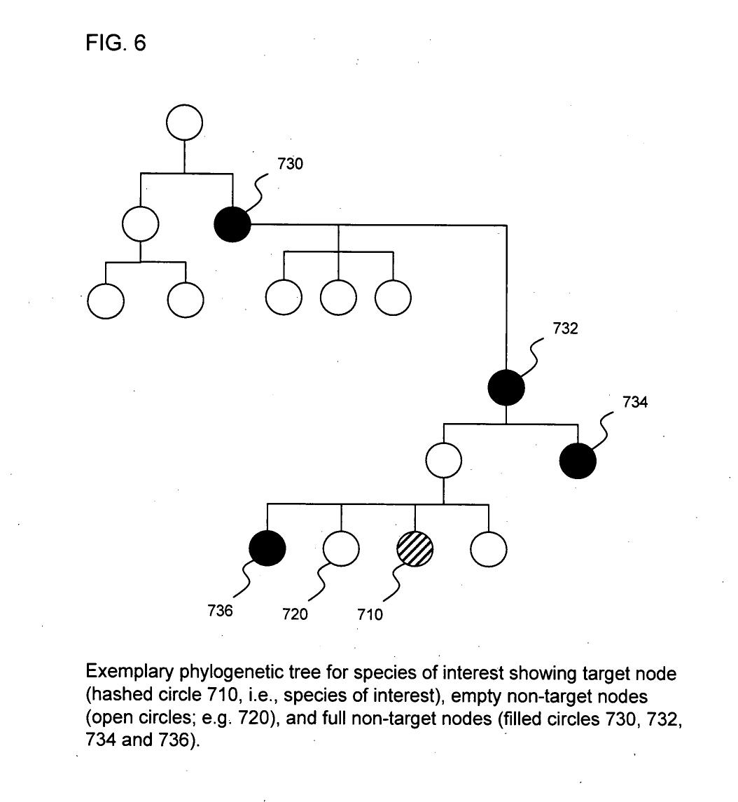

In certain embodiments, the repeat library manager is further configured to prompt a user if all of the non-target nodes in a phylogenetic tree(s) having known repeat library sets have been excluded (e.g., do not meet the threshold requirement for the target node relatedness value or values). In this event, a user may be prompted to select one or more non-target node having a known repeat library associated with it to use for downstream dynamic repeat library generating steps. For example, a system of the invention may display to a user on a GUI the one or more phylogenetic trees obtained by the node manager in which each of the non-target nodes having associated known repeat libraries are highlighted or marked distinguishably from non-target nodes having no known repeat library (e.g., have poorly characterized genomes and/or transcriptomes). Non target nodes having known repeat library sets are referred to herein as “full” nodes, whereas non target nodes lacking known repeat library sets are referred to herein as “empty” nodes (this nomenclature is used in FIG. 6). Once displayed, the user may select a non-target node having a known repeat library to either include in generating the repeat library for the target node (e.g., by clicking a non-target node on the GUI with a cursor controlled by a conventional computer mouse). In this way, the user can guide the repeat library manager with respect to the non-target node(s) to use in dynamically generating a repeat library for the target node (or species of interest).

In certain embodiments, the dynamic repeat library generating process is iterative. For example, when the node manager cannot identify a non-target node in the obtained phylogenetic tree(s) that meets the target node relatedness value threshold, the thresholds may be adjusted one or more times to determine whether any non-target nodes in the phylogenetic tree(s) can be identified that have associated known repeat libraries. For example, the node manager may be configured to automatically lower the target node relatedness threshold value by a predetermined amount, or prompt a user to input a lower threshold value, if a repeat library set cannot be generated employing the initially chosen target node relatedness threshold value.

Following generation of the repeat library set for the target node (i.e., the species of interest), the system provides the set to the user. As such, the system is further configured to communicate to the user the dynamically generated repeat library set. Along with the generated repeat library set, where desired, the system may also provide to the user any information relating to the generation of the repeat library set, including the phylogenetic trees, target node relatedness values of the non-target nodes in the phylogenetic trees, threshold value(s) employed in generating the repeat library, the history of repeat library generation (i.e., a report detailing the steps in generating the repeat library), known repeat library sets for the non-target nodes in the phylogenetic trees, etc. The format of communication may vary, and may be displayed graphically to the user, e.g., in a graphical format, or may be sent electronically, e.g., via email communication.

While the above description of aspects of the system and methods has been provided in terms of producing a single repeat library set for a given user input species of interest, the system may dynamically generate two or more distinct repeat library sets for a given target, e.g., which were generated using a different phylogenetic tree(s) and/or distinct target node relatedness value threshold(s). As such, that the user may be provided with two or more different repeat library sets. In these embodiments, the user may then select the set or sets which best meet the user's particular needs.

A flow diagram implementing certain aspects of the methods of the invention is provided in FIG. 5. At step 610, a user identifies and/or inputs a species of interest into the system. Next, at step 620, the he node manager obtains one (or more) phylogenetic tree having a target node (the species of interest) and non-target nodes (related species). The node manager obtains a target node-relatedness value for the non-target nodes. At step 630, the repeat library manager identifies non-target nodes that have repeat libraries (e.g., using the repeat library database) and generates a repeat library for the species of interest based on known repeat libraries of the identified non-target nodes and their respective target node relatedness value.

FIG. 6 shows an exemplary phylogenetic tree having nodes as described herein. In this figure, target node 710 needs a repeat library generated for it (i.e., it is the species of interest identified/input by the user). Such a repeat library can be based on a related non-target node that has a known repeat library associated with it (also called a “full” non-target node). Such nodes are shown in FIG. 6 as filled circles 730, 732, 734 and 736. “Empty” non-target nodes in this figure, i.e., non-target nodes lacking known repeat libraries, are shown as open circles (e.g., node 720). Based on this phylogenetic tree, the repeat library generated for the target node 710 may include repeat library elements from “full” sister node 736 and “full” parent nodes 732 and 730. Alternatively, if no “full” sister or parent nodes are available (meaning that full nodes 732, 734 and 736 are empty nodes), the repeat library for “full” node 734 may be used to generate the repeat library for target node 710.

As described above, multiple phylogenetic trees may be employed in generating repeat library sets for a species of interest. In certain of these embodiments, the target node relatedness value for a given node may be an average of the target node relatedness values for that node in the different trees.

Provided below is en exemplary XML configuration file for defining the distances between the nodes, or species (i.e., parent-children relationships), a threshold value of each species (which is given by the user), and the quantity score of the repeat database of each species. The software tool uses the above parameters to determine whether or not to include into the result repeat library file the available repeat library of a parent species and/or the repeat database of a neighboring species.

```
<?xml version=“1.0” encoding=“UTF-8”?>
<!DOCTYPE DynamicRepeatDBGenerator
[
    <!ENTITY THRESHOLD1 “100”>
    <!ENTITY THRESHOLD2 “200”>
    <!ENTITY THRESHOLD3 “300”>
    <!ENTITY QUANTITY1 “1000”>
    <!ENTITY QUANTITY2 “5000”>
]>
<Config>
<PhylogeneticTree>
<Species Name=“A” Threshold=“ &THRESHOLD1;”
Quantity=“&QUANTITY2;”>
    <Species Name=“B” Threshold=“ &THRESHOLD3;”
    Quantity=“&QUANTITY2;”>
        <Species Name=“C”
        Threshold=“ &THRESHOLD3;” Quantity=“&QUANTITY2;”/>
        <Species Name=“x”
        Threshold=“ &THRESHOLD2;” Quantity=“&QUANTITY1;”>
            <Species Name=“D”
            Threshold=“ &THRESHOLD1;”
            Quantity=“&QUANTITY1;”/>
            <Species Name=“G”
            Threshold=“ &THRESHOLD3;”
            Quantity=“&QUANTITY2;”/>
        </Species>
    </Species>
</Species>
</ PhylogeneticTree >
</Config>
```

The result of the process is a database file defining a repeat library set for the species of interest that contains all repeat sequences taken from repeat libraries of closely related species in the given phylogenetic tree that meet the threshold requirements. The database file can then be used in probe design process to mask out possible repeat sequences of the novel species.

For example, one may use the repeat library to inform a probe design process to obtain probes specific for targets of interest in the species of interest that excludes probes that hybridize with the sequences in the generated repeat library set. Such probe/probe sets find use in a variety of different applications, where such applications include, but are not limited to, analyte detection applications in which the presence of a particular analyte in a given sample is detected at least qualitatively, if not quantitatively. Analyte detection methods include, but are not limited to, northern blots, western blots, dot blots, southern blots, etc.

In certain embodiments, a probe set(s) designed as informed by the repeat library generated using the subject system and methods are employed in a chemical array format. Any convenient method for carrying out assays employing a chemical array(s) may be used. In certain of such methods, the sample suspected of comprising the analyte of interest is contacted with an array of immobilized probes obtained according to the subject methods under conditions sufficient for the analyte to bind to the probe. Thus, if the analyte of interest is present in the sample, it binds to the array at the site of its cognate probe and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of a signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; and 6,180,351. In certain embodiments, the subject methods include a step of transmitting data from at least one of the detecting and deriving steps, as described above, to a remote location.

As such, in using an array having probes obtained by the system and method of the present invention, the array will typically be exposed to a sample (for example, a fluorescently labeled analyte, e.g., nucleic acid containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

In certain embodiments, the systems may include additional functionalities. For example, in certain embodiments the system includes a probe design manager, where the probe design manager is configured to design a probe or set of probes for a target in a species of interest as informed by the generated repeat library. In these embodiments, the probe design manager may obtain and qualify probes from a probe database of the system and/or may design a probe or probe set de novo using a probe design algorithm.

In certain embodiments, the systems include an array layout functionality, e.g., as described in copending application Ser. No. 11/001,700. In certain of these embodiments, the system includes an array layout developer, where the array layout developer includes a memory having a plurality of rules relating to array layout design and is configured to develop an array layout based on the application of one or more of the rules to information that includes array request information received from a user.

In certain embodiments, the output manager further provides a user with information regarding how to purchase the identified probe set, e.g., alone or in an array. In certain embodiments, the information is provided in the form of an email. In certain embodiments, the information is provided in the form of web page content on a graphical user interface in communication with the output manager. In certain embodiments, the web page content provides a user with an option to select for purchase one or more synthesized probe sequences. In certain embodiments, the web page content includes fields for inputting customer information. In certain embodiments, the system can store the customer information in the memory. In certain embodiments, the customer information includes one or more purchase order numbers. In certain embodiments, the customer information includes one or more purchase order numbers and the system prompts a user to select a purchase order number prior to purchasing the one or more synthesized probe sequences.

In certain embodiments, in response to the purchasing, the one or more probe sequences of probe set are synthesized on an array. In certain embodiments, the methods include ordering synthesized probe(s) that include the sequences of the selected probe group. In certain embodiments, the synthesized probes are synthesized on an array. In certain embodiments, the inputting is via a graphical user interface in communication with the system.

In certain embodiments, the user may choose to obtain an array having the generated probe(s) present therein. As such, the generated probe can be included in an array layout, and an array fabricated according to the array layout that includes the generated probe. In certain embodiments, the user may specify the location of the probe in the product layout. Specifying may include choosing a particular location in a given layout, or choosing from a section of system-provided array layout options in which the probe is present at various locations. Array fabrication according to an array layout can be accomplished in a number of different ways. With respect to nucleic acid arrays in which the immobilized nucleic acids are covalently attached to the substrate surface, such arrays may be synthesized via in situ synthesis in which the nucleic acid ligand is grown on the surface of the substrate in a step-wise fashion and via deposition of the full ligand, e.g., in which a presynthesized nucleic acid/polypeptide, cDNA fragment, etc., onto the surface of the array.

Where the in situ synthesis approach is employed, conventional phosphoramidite synthesis protocols are typically used. In phosphoramidite synthesis protocols, the 3′-hydroxyl group of an initial 5′-protected nucleoside is first covalently attached to the polymer support, e.g., a planar substrate surface. Synthesis of the nucleic acid then proceeds by deprotection of the 5′-hydroxyl group of the attached nucleoside, followed by coupling of an incoming nucleoside-3′-phosphoramidite to the deprotected 5′ hydroxyl group (5′-OH). The resulting phosphite triester is finally oxidized to a phosphotriester to complete the internucleotide bond. The steps of deprotection, coupling and oxidation are repeated until a nucleic acid of the desired length and sequence is obtained. Optionally, a capping reaction may be used after the coupling and/or after the oxidation to inactivate the growing DNA chains that failed in the previous coupling step, thereby avoiding the synthesis of inaccurate sequences.

In the synthesis of nucleic acids on the surface of a substrate, reactive deoxynucleoside phosphoramidites are successively applied, in molecular amounts exceeding the molecular amounts of target hydroxyl groups of the substrate or growing oligonucleotide polymers, to specific cells of the high-density array, where they chemically bond to the target hydroxyl groups. Then, unreacted deoxynucleoside phosphoramidites from multiple cells of the high-density array are washed away, oxidation of the phosphite bonds joining the newly added deoxynucleosides to the growing oligonucleotide polymers to form phosphate bonds is carried out, and unreacted hydroxyl groups of the substrate or growing oligonucleotide polymers are chemically capped to prevent them from reacting with subsequently applied deoxynucleoside phosphoramidites. Optionally, the capping reaction may be done prior to oxidation.

With respect to actual array fabrication, in certain embodiments, the user may itself produce an array having the generated array layout. In yet other embodiments, the user may forward the array layout to a specialized array fabricator or vendor, which vendor will then fabricate the array according to the array layout.

In yet other embodiments, the system may be in communication with an array fabrication station, e.g., where the system operator is also an array vendor, such that the user may order an array directly through the system. In response to receiving an order from the user, the system will forward the array layout to a fabrication station, and the fabrication station will fabricate the array according to the forwarded array layout.

Arrays can be fabricated using drop deposition from pulsejets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein. Also, instead of drop deposition methods, light directed fabrication methods may be used, as are known in the art. Inter-feature areas need not be present particularly when the arrays are made by light directed synthesis protocols.

The invention also provides programming, e.g., in the form of computer program products, for use in practicing the repeat library set generating methods of the invention. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. Any convenient medium or storage method can be used to create a manufacture that includes a recording of the present programming/algorithms for carrying out the above described methodology.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A system for generating a repeat library for a species of interest, said system comprising:
(A) a communication module comprising an input manager for receiving input from a user and an output manager for communicating output to a user;
(B) a processing module comprising:
(1) a node manager configured to:
(a) obtain a phylogenetic tree for a species of interest based on input from a user, wherein said phylogenetic tree comprises a target node and non-target nodes, wherein said species of interest is said target node and species related to said species of interest are said non-target nodes; and
(b) obtain a target node relatedness value for each non-target node; and
(2) a repeat library manager, wherein said repeat library manager is configured to:
(a) identify a non-target node having a known repeat library in said phylogenetic tree; and
(b) generating a repeat library for said species of interest based on said known repeat library of said identified non-target node and its respective target node relatedness value.

2. The system of claim 1, wherein said user input is selected from: a species indicator for said species of interest, a phylogenetic tree for said species of interest, a choice of phylogenetic tree generating algorithm, a species indicator for one or more of said related species.

3. The system of claim 1, wherein said repeat library manager is configured to identify multiple non-target nodes having a known repeat library in said phylogenetic tree.

4. The system of claim 3, wherein said node manager is further configured to exclude from said generating step any of said identified non-target nodes if its respective target node relatedness value exceeds a threshold value.

5. The system of claim 4, wherein said threshold value is provided by a user of said system.

6. The system of claim 3, wherein said repeat library manager is further configured to prompt said user if all of said identified non-target node are excluded.

7. The method of claim 1, wherein said target node relatedness value is selected from one or more of: a bonus value, a cost value, and a certainty value.

8. The system of claim 1, wherein said repeat library manager is further configured to communicate to said user said generated repeat library for said species of interest.

9. The system of claim 1, wherein said node manager is further configured to allow said user to select which of said non-target nodes in said phylogenetic tree to use for generating said repeat library for said species of interest.

10. The system of claim 1, wherein said node manager is configured to obtain multiple phylogenetic trees for said species of interest, wherein said one or more target node relatedness value for each non-target node is based on a summation of said multiple phylogenetic trees.

11. A method of generating a repeat library for a species of interest, said method comprising:
(a) identifying by a user a species of interest;
(b) obtaining a phylogenetic tree for said species of interest, wherein said phylogenetic tree comprises a target node and non-target nodes, wherein said species of interest is said target node and species related to said species of interest are said non-target nodes, and wherein each non-target node comprises a target node relatedness value;
(c) identifying a non-target node in said phylogenetic tree having a known repeat library;
(d) generating a repeat library for said species of interest based on said known repeat library and said target node relatedness value; and
(e) outputting said generated repeat library for said species of interest to said user.

12. The method of claim 11, wherein multiple non-target nodes having a known repeat library are identified in said phylogenetic tree.

13. The method of claim 12, wherein said method further comprises selecting by said user non-target nodes to be used in said generating step from said identified non-target nodes in said phylogenetic tree having known repeat libraries.

14. The method of claim 11, wherein said obtaining said phylogenetic tree is selected from: producing a phylogenetic tree de novo and retrieving a previously produced phylogenetic tree.

15. The method of claim 14, wherein said previously produced phylogenetic tree is provided by said user.

16. The method of claim 12, wherein any of said identified non-target nodes is excluded from said generating step if its respective target node relatedness value exceeds a threshold value.

17. The method of claim 16, wherein said threshold value is input by said user.

18. The method of claim 16, wherein said method further comprises lowering said threshold value if all of said identified non-target nodes are excluded.

19. The method of claim 11, wherein said target node relatedness value is selected from one or more of: a bonus value, a cost value, and an certainty value.

20. The method of claim 11, wherein said outputting to said user is via the internet.

21. The method of claim 11, wherein multiple phylogenetic trees are obtained for said species of interest, and wherein said target node relatedness value for each non-target node is based on a summation of said multiple phylogenetic trees.

22. A computer program product comprising a computer readable storage medium having a computer program stored thereon, wherein said computer program, when loaded onto a computer, operates said computer to generate a repeat library for a species of interest by:
(a) obtaining a phylogenetic tree for said species of interest, wherein said phylogenetic tree comprises nodes representing each species in said phylogenetic tree, wherein said species of interest is the target node, and wherein each non-target node comprises one or more target node relatedness value;
(b) identifying non-target nodes in said phylogenetic tree having known repeat libraries; and
(c) generating a repeat library for said species of interest based on said known repeat libraries and said one or more target node relatedness value.

23. A method of receiving repeat library for a species of interest, said method comprising:
(a) inputting a species of interest into the system of claim 1; and
(b) receiving a repeat library for said species of interest.

24. The method of claim 23, wherein said method further comprises inputting a threshold value, for one or more target node relatedness value.

25. The method of claim 23, wherein said method further comprises selecting an identified non-target node having a known repeat library to be used in said generating step.
